(19) United States
(12) Patent Application Publication
(10) Pub. No.: US 2011/0151973 A1
(43) Pub. Date: Jun. 23, 2011

(54) Portable Computer With Multiple Graphics Displays

(76) Inventors: Mark C. Solomon, San Jose, CA (US); Luca Di Fiore, Taipei (TW); Rahul Sood, Calgary (CA)

(21) Appl. No.: 13/060,386

(22) PCT Filed: Aug. 30, 2008
(86) PCT No.: PCT/US2008/074946

§ 371 Date: Feb. 23, 2011

(51) Int. Cl. A63F 13/00; A63F 9/24

(52) U.S. Cl. 463/31; 463/46

(57) ABSTRACT

A portable computer comprises a base and a display lid hingeably coupled to the base. The display lid comprises a front surface and first and second graphics displays mounted in the display lid and viewable from the front surface. The second graphics display is smaller than the first display. Other portable computers include the second graphics display in the base rather than in the display lid.

### BACKGROUND

Many software programs are most desirably used on a computer comprising more than one display. Gaming, for example, often entails displaying, not just the visual game play views, but also statistics, maps, chat or dialog information with other players, an inventory of weapons and munitions, etc. Playing such a game or executing other types of applications benefiting from multiple displays is very cumbersome on a portable, notebook computer which typically only has one display.

### BRIEF DESCRIPTION OF THE DRAWINGS

For a detailed description of exemplary embodiments of the invention, reference will now be made to the accompanying drawings in which:

FIG. 1 shows a portable computer in accordance with various embodiments in which a second graphics display is provided in the display lid of the main display;

FIG. 2 shows another embodiment in which a second graphics display is provided to one side of the keyboard on the base of a portable computer;

FIG. 3 shows another embodiment in which the second graphics display is provided below the keyboard on the base of the computer;

FIG. 4 shows a system diagram of the portable computers of FIGS. 1-3; and

FIG. 5 shows a printed circuit board (PCB) mounted behind the second graphics display.

### NOTATION AND NOMENCLATURE

Certain terms are used throughout the following description and claims to refer to particular system components. As one skilled in the art will appreciate, computer companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . .” Also, the term “couple” or “couples” is intended to mean either an indirect, direct, optical or wireless electrical connection. Thus, if a first device couples to a second device, that connection may be through a direct electrical connection, through an indirect electrical connection via other devices and connections, through an optical electrical connection, or through a wireless electrical connection.

### DETAILED DESCRIPTION

The following discussion is directed to various embodiments of the invention. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

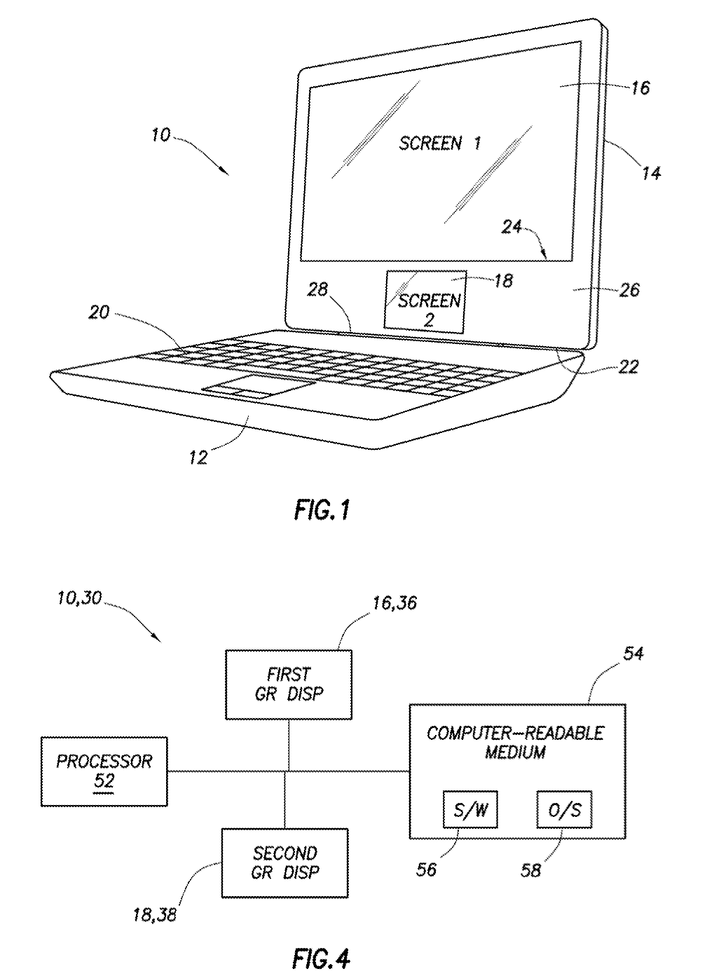

FIG. 1 shows an embodiment of a portable computer 10 comprising a base 12 and display lid 14 hingeably coupled to the base 12 via a hinge 28. The display 14 can be opened and closed. When opened, a front surface 26 is presented to the user for viewing a first graphics display 16. To close the computer 10, the display lid is rotated downward with the front surface 26 lowering towards the keyboard 20 provided on the base 12. When closed, the front surface 26 is not viewable.

The display lid 14 comprises two graphics displays—the first graphics display 16 and a second graphics display 18. Both graphics displays 16, 18 are viewable from the front surface 26 when the display lid is in the open position as shown in FIG. 1. In the embodiment of FIG. 1, the second graphics display 18 is smaller than the first graphics display 16. In some particular embodiments, the second graphics display is at least 75% smaller than the first display when measured using the diagonal dimensions of the displays. In other embodiments, the second graphics display 18 comprises ⅙^{th} of the number of pixels as the first graphics display 16 and the second graphics display is 20-25% of the size (in terms of dimensions) of the first graphics display 16. In some embodiments, the second graphics display 18 is half the size of the first graphics display 16. The second graphics display 18 also can be detachable and used separately from the portable computer 10 as, for example, a media device such as for playing music, a gaming device, a remote control, a wireless telephone, PDA, etc.

In the embodiment of FIG. 1, the second graphics display 18 is located between the first graphics display 16 (specifically between bottom edge 24 of the graphics display 16) and the bottom edge 22 of the display lid 14. The bottom edge 22 is the edge generally adjacent the base 14 and the edge that is hinged to the base via the hinge 28.

In some embodiments, both display graphics displays 16 and 18 comprise liquid crystal displays (LCDs), but can be other types of displays as desired.

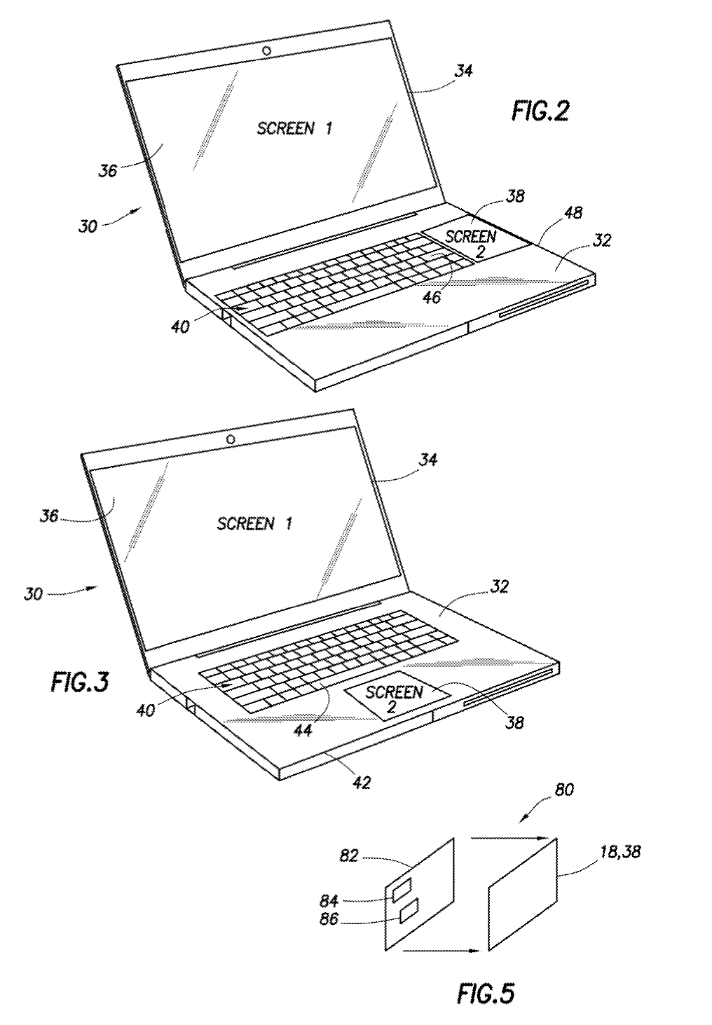

FIG. 2 illustrates another embodiment of a portable computer 30 also comprising a display lid 34 hingeably coupled to a base 32. A first graphics display 36 is provided in the display lid 34. The base comprises a keyboard 40 and a second graphics display 38 provided on the base to one side of the keyboard 40. In the embodiment shown in FIG. 2, the second graphics display 38 is provided to the right of the keyboard 40. At least a portion of the second graphics display 38 is to the right of the “enter” button 46 on the keyboard 40. In other embodiments the second graphics display 38 is provided to the left of the keyboard 40, which would be positioned towards the right edge 48 of the base 32 to make room for the second graphics display.

FIG. 3 illustrates another embodiment of portable computer 30 in which the second graphics display 38 is provided below the keyboard 40. “Below” the keyboard 40 in this context means that the second graphics display 38 is located between the keyboard 40 and a front edge 42 of the base 32. The keyboard 40 comprises, among other keys, a space bar 44 generally at the bottom and generally in the middle of the keys that comprise the keyboard. The second graphics display 38 is placed so that at least a portion, and in some embodiments all, of the second graphics display 38 is between the space bar 44 and the front edge 42 of the base 32.

As with the second graphics display 18 of FIG. 1, in the embodiments of FIGS. 2 and 3, the second graphics display 38 is smaller than the first graphics display 36. In some embodiments, the second graphics display 38 is at least 75% smaller than the first display when measured using the diagonal dimensions of the displays.

FIG. 4 shows an illustrative system diagram of portable computer 10, 30. As shown, the portable computer comprises a processor 54 coupled to a computer-readable medium (CRM) 54. The CRM 54 comprises volatile memory such as random access memory (RAM), non-volatile storage such as a hard disk drive, read-only memory (ROM), a compact disc read-only memory (CD ROM), etc., or combinations thereof. The CRM 54 comprises an operating system 58 and one or more software applications 56. The operating system 58 and software application 56 are executed by the processor 54. In various embodiments, the operating system 58 provides graphical support for driving multiple displays such as first graphics display 16, 36 and second graphics display 18, 38. An example of such an operating system is the WINDOWS operating system (from Microsoft Corporation) with a feature called “SideShow.”

The application 56 may be any type of application. One example of an application is a user-interactive game. The main views needed by the user to play the game are rendered on the larger graphics display 16, 36 while information such as maps, inventory of weapons, status, etc. associated with the game are rendered on the smaller graphics display 18, 38. Without the second display, such associated information would have to be displayed on the first (and only) graphics display 16, 38 by either making the content smaller on the display to make room for the associated information or by overlaying the associated information on top of the main content. The embodiments disclosed herein solve that problem thereby providing the user with an uninterrupted, immersive gaming experience.

In various embodiments, the second graphics displays 18, 38 are graphics displays as noted above, and not text-only displays. For example, the second graphics displays are not one or two line dot matrix text displays. Instead, the second graphics displays can be used to render both text as well as graphics.

In some embodiments such as that shown in FIG. 5, a printed circuit board (PCB) 82 is provided immediately behind the second graphics display 18, 38 to form a display module 80. The PCB 82 receives an input voltage and includes one or more DC-to-DC converters 84 that provide one or more different DC voltage levels. If the PCB is a multi-layer PCB, different layers can carry different DC voltages depending on the needs of the display. The PCB preferably also includes a converter 84 that converts graphics data from the format of the processor of the computer 10, 30 to whatever format (e.g., RGB format) the display 18, 38 requires.

If desired, the second graphics display 18, 38 can be touch-sensitive and used as a touchpad. Function as a touchpad, the user can move a cursor on the first graphics display. The second graphics display can also be touch-sensitive to interact with information shown on the second graphics display (e.g., to select a feature being shown, etc.).

In various embodiments, signals pass through the hinge 28 between the base 12 and graphics display 18. The signals may comprise data and/or power. In some embodiments, all such signals are combined into a single cable that is routed through the hinge. In other embodiments, subsets of the signals are combined into individual cables and thus more than one cable may be routed through the hinge.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1. A portable computer, comprising:
a base; and
a display lid hingeably coupled to the base, the display lid comprising a front surface and first and second graphics displays mounted in said display lid and viewable from the front surface;
wherein the second graphics display is smaller than the first display.

2. The portable computer of claim 1 wherein the second graphics display is located between the first graphics display and a bottom edge of the display lid adjacent the base.

3. The portable computer of claim 1 wherein the second graphics display is at least 75% smaller than the first graphics display.

4. The portable computer of claim 1 further comprising a processor that executes software that displays data on said first graphics display and associated data on said second graphics display.

5. The portable computer of claim 4 wherein said software comprises a game and said associated data comprises status information associated with said game.

6. The portable computer of claim 1 wherein the second graphics display is touch-sensitive.

7. A portable computer, comprising:
a display lid containing a first graphics display; and
a base containing a keyboard and a second graphics display;
wherein the display is hingeably coupled to the base.

8. The portable computer of claim 7 wherein the second graphics display is at least 75% smaller than the first graphics display.

9. The portable computer of claim 7 wherein the second graphics display is located to one side of the keyboard.

10. The portable computer of claim 7 wherein the second graphics display is located between the keyboard and a front edge of the base.

11. The portable computer of claim 7 further comprising a processor that executes software that displays data on said first graphics display and associated data on said second graphics display.

12. The portable computer of claim 11 wherein said software comprises a game and said associated data comprises status information associated with said game.

13. The portable computer of claim 7 wherein the second graphics display is touch-sensitive.
